(19) United States
(12) Patent Application Publication
(10) Pub. No.: US 2022/0267965 A1
(43) Pub. Date: Aug. 25, 2022

(54) Methods For Preparing and Installing a Natural Stone Surface and a Tiled Natural Stone Paving System Therefor

(71) Applicant: Michael Allan WELSH, Huntsville (CA)

(72) Inventors: Michael Allan WELSH, Huntsville (CA); Wesley Roy RADTKE, Huntsville (CA)

(73) Assignee: Michael Allan WELSH, Huntsville (CA)

(21) Appl. No.: 17/651,706

(22) Filed: Feb. 18, 2022

Related U.S. Application Data
(63) Continuation-in-part of application No. 17/249,216, filed on Feb. 24, 2021.

(51) Int. Cl. E01C 5/02; B28D 1/02

(52) U.S. Cl. CPC E01C 5/02; B28D 1/02

(57) ABSTRACT

A system and method are provided for designing/creating, preparing, and installing a natural stone tiled surface at a site that provides a perception of randomness to the observer while actually following a predefined pattern that facilitates simple installation by unskilled trades and allows for the advanced preparation of the stone tiles used. Advanced preparation of the stone tiles allows the offloading of at least some cutting, preparation and installation steps normally required onsite, to an offsite location. The system relies on the tessellation or tiling of a specific outline of an irregular concave polygon, that itself includes an internal set of irregular convex polygon shapes. The tessellation of an outline that includes such a set of shapes provides an optical effect that makes it difficult for an observer to recognize the repeating nature of the stones within the patterned outline. The system can include one or more orthogonal reference lines to align with reference edges.

### CROSS-REFERENCE TO RELATED APPLICATION(S)

This application is a Continuation-In-Part of U.S. patent application Ser. No. 17/249,216 filed on Feb. 24, 2021, the contents of which are incorporated herein by reference.

### TECHNICAL FIELD

The following generally relates to tiled natural stone surfaces such as patios, and specifically to a system having a set of shapes of natural stone tiles, and to methods of creating or preparing such as system, and to methods of installing same.

### BACKGROUND

Natural stone tiles of a pre-cut thickness are a highly desirable material with which to create a laid or paved surface such as a walkway, patio or other walkable surface. In particular, natural stone tile is a popular material for creating an outdoor patio or pathway.

One of the attractive features of a natural stone patio, when made up of tightly-packed tiles with irregular outlines, is the perceived or actual randomness to the shapes and sizes of each individual stone when combined with the variations and randomness of the surface of tiles, providing a customized and high-end effect. The downside of providing such randomness via a random tiling approach is the expense of creating and installing natural stone tiles. For instance, it typically requires a skilled artisan capable of creating an intricate random pattern through the cutting of random rock shapes into tiles that can be closely packed, typically onsite.

Natural stone patios are typically much more expensive than the installation of man-made, pre-fabricated tiles or “pavers”, often of concrete or clay brick materials. The process of creating such materials and the installation methods of said material are completely different that those used for natural stone paving. In addition, they are typically arranged in predefined often simple patterns clearly visible to the casual observer.

In addition to the time and effort required to cut and create the randomized tile patterns and despite best efforts, the manual cutting process used to create stone tiles can result in inconsistent gaps between the stones or require additional waste through selection of different stones to create a better fit. The installation of a natural stone tile patio can therefore be costly and time consuming unless the tile cutting is efficient and precise.

Additionally, the rock cutting process is loud, disruptive and messy. It can also be dangerous when created using portable cutting tools at the installation site. This also requires cleanup and can add disruption to the customer as well as those in the vicinity of the worksite.

It is an object of the following to address at least one of the above-noted disadvantages.

### SUMMARY

It is recognized that a paving system that can be prepared in advance at another location and installed quickly according to a predefined repeating pattern layout plan is desirable. However, it is difficult to create a desirable illusion of randomness when installing according to a predefined repeating pattern plan. The following describes a system and method for creating a substantially flat (e.g., paved) tiled surface by cutting natural stone into sets of predefined substantially flat shapes of similar thickness, each shape including straight edges such that the cut stone shapes can be placed adjacent one another according to a predefined outline, to achieve a continuous surface where the arrangement of the tiles within the surface, as well as the varied look of the surface of each tile, provides a perception of randomness to the observer. The sets of shapes defined within the tessellation outline can also be configured to include one or more reference lines corresponding to edges of certain shapes in the set, which are orthogonal to or parallel/aligned to/with a direction along which the pattern repeats. A plurality of non-adjacent, collinear edges within the pattern can further simplify alignment when repeating the tessellation outline in a tessellation pattern. In this way, the overall tessellation outline can be cut either offsite or onsite in a consistent manner for installation.

In one aspect, there is provided a method of preparing a set of natural stone shapes for installation as a tiled surface, comprising: determining a tessellation outline comprising three or more sides; dividing the tessellation outline into a plurality of internal two dimensional shapes, wherein at least one of the plurality of shapes comprises an edge defining a reference line that is orthogonal or parallel to a repeating direction of installation; and cutting one or more natural stone slabs into each of the plurality of shapes to form at least one set.

In another aspect, there is provided a method of installing a tiled natural stone surface, comprising: cutting one or more natural stone slabs into each of a plurality of two dimensional shapes that form at least one set of shapes, wherein each set of shapes, when combined, form a tessellation outline comprising three or more sides, and wherein at least one of the plurality of shapes comprises an edge defining a reference line that is orthogonal or parallel to a repeating direction of installation; and arranging the plurality of shapes according to the tessellation outline to install the natural stone surface.

In yet another aspect, there is provided a tiled natural stone paving system, comprising a plurality of two dimensional shapes cut from natural stone that form at least one set of shapes, wherein each set of shapes, when combined, form a tessellation outline comprising three or more sides, wherein the plurality of shapes are arranged according to the tessellation outline and the outline is tessellated to create the natural stone surface, and wherein at least one of the plurality of shapes comprises an edge defining a reference line that is orthogonal or parallel to a repeating direction of installation.

### BRIEF DESCRIPTION OF THE DRAWINGS

Embodiments will now be described with reference to the appended drawings wherein:

FIG. 1 is a schematic diagram of a tessellation outline.

FIG. 2 is a schematic diagram of a tessellation of the outline of FIG. 1 to form a repeating pattern.

FIG. 3 is a schematic diagram of the tessellation outline containing an internal set of five pseudo-random shapes.

FIG. 4 is a schematic diagram of a tessellation of the outline of FIG. 3 showing a repeating pattern of the internal set of five pseudo-random shapes.

FIG. 5 is a schematic diagram of the tessellation outline containing an internal set of seven pseudo-random shapes.

FIG. 6 is a schematic diagram of a tessellation of the outline of FIG. 5 showing a repeating pattern of the internal set of seven pseudo-random shapes.

FIG. 7A is an image of a patio showing a tessellation of a set of five shapes according to a tessellation outline.

FIG. 7B is a variation of the image shown in FIG. 7A accommodating an internal obstruction.

FIG. 8 is a flow chart illustrating operations performed in preparing and installing a natural stone surface.

FIG. 9 is a plan view of a tessellation outline overlay illustrating a configuration incorporating one or more reference lines orthogonal or parallel to reference edge(s).

FIG. 10 is a tessellation including a plurality of tessellation outlines illustrating alignment of parallel and orthogonal lines.

FIG. 11 illustrates the tessellation of FIG. 10 with a set of cut lines to illustrate reference edges that can be incorporated into that tessellation.

FIG. 12 illustrates a cut portion of a tessellation outline that can be reused in another portion of the tessellation.

FIG. 13 illustrates the tessellation of FIG. 12 showing multiple reuse options and a reference edge against which the tessellation is laid.

FIG. 14 illustrates use of the orthogonal lines to form a path or walkway using multiple ones of the tessellation outline.

FIG. 15 illustrates a tessellation outline cut to form a corner starter.

FIG. 16 illustrates a tessellation being laid from a reference edge that is orthogonal to the reference edge shown in FIG. 13.

### DETAILED DESCRIPTION

The following describes a system and method for designing/creating, preparing, and installing a natural stone tiled surface at a site that provides a perception of randomness to the observer while actually following a predefined pattern that facilitates simple installation by unskilled trades and allows for the advanced preparation of the stone tiles used. Advanced preparation of the stone tiles allows the offloading of at least some cutting, preparation and installation steps normally required onsite, to an offsite location. In this way, significant time and cost savings can be achieved by shifting time and resources to an offsite location, which minimizes disruptions onsite, allows the building of an inventory of standard shapes, all without compromising the aesthetics or quality of the installation. In addition, the actual installation time is reduced because the predefined layout of the stone tiles requires little skill or effort to install.

Natural stone tiles are fabricated from large rough rocks that have been excavated at a quarry using drilling, blasting, and sawing techniques. The rough rocks are typically cut or hand-split into irregular shapes of rectangular slices about four feet wide by four feet tall and about ½ inch to 3 inches in thickness, using large rock cutting saws located at the quarry site. The slices are usually too large, heavy and randomly shaped to be used directly as paving tiles and are thus transported to the paving installation site and manually cut into smaller random shapes with sides of varying lengths between 6 inches and 48 inches that can be pieced together to create a continuous paved surface by skilled craftsmen using portable cutting tools. The process of cutting stones on site that will fit tightly together in a random pattern without overlaps typically requires the ability of a skilled craftsperson and is very time consuming when compared to paving systems using prefabricated man-made bricks or slabs.

The described system relies on the tessellation or tiling of a specific outline of an irregular concave polygon, that itself includes an internal set of irregular convex polygon shapes. The tessellation of an outline that includes such a set of shapes provides an optical effect that makes it difficult for an observer to recognize the repeating nature of the stones within the patterned outline. This perception of randomness is enhanced by the actual variations or randomness of the natural stone surface of the tiles (i.e., different shades, striations, textures, etc.), to make the repeating pattern difficult to discern to the casual observer.

The system described herein can also create cost savings through the simplification of the stone tile cutting process, namely by only cutting a set of standard shapes. In this way, shapes may not need to be cut on site to fit both the installation and the raw material available at the time. Moreover, less setup time is required for each cut and a better utilization of the available stones can be achieved. Similarly, this aspect of the system can allow for the use of larger, faster, and more efficient cutting machines than can typically be operated at the job site due to their size, weight, and lack of portability in general. Rather than cutting and piecing together random stones on site, the predefined pattern within the outline can be more quickly installed, reducing overall installation time on site. Cutting offsite can also have a safety advantage by using fixed-place machines with built-in safety and rock handling features, minimizing or even avoiding the use of concrete “quick cut” saws normally used for onsite cutting.

This simplification can also reduce the need for skilled labor. As noted above, traditional stone patios typically require a skilled artisan capable of creating an intricate random pattern by cutting random rock shapes that will fit tightly together. By predefining the outline and internal shapes as described below, at least some skilled labor is not required and the described precut stones can be quickly installed because they are designed to fit together tightly in a predefined pattern without custom cutting to fit. By doing at least some (and possibly the majority) of the cutting process off site and beforehand, there can be less disruption at the installation site, along with less debris, dust, and noise pollution. It can also be appreciated that by pre-cutting stones, fewer offcuts and debris means that less material is required to be shipped to the site, thus lowering transportation costs, including delivery and removal of the debris.

The system described herein therefore provides an aesthetically appealing paved surface with a lower cost of installation than conventional custom stone paving, through the use of a repeating pattern giving a perception of randomness, allowing the use of lower cost labor with faster installation time. This can also lead to a better utilization of raw materials through creating an inventory of standard-shaped tiles with material wastage minimized by the elimination of the need for custom outlines, etc. on site. By forming the standard-shapes as irregular convex polygons, simpler and faster cutting can be achieved using rock cutting saws that only make straight through cuts for the sides of the tiles as they meet at convex angles. In addition to increasing the number of installations possible (due to faster installations), fewer artisans/craftspeople are required, and the overall process can become more environmentally friendly through off site rock cutting in a safer, pollution-controllable environment. These advantages likewise can lead to increased customer satisfaction due to the increased speed and decreased noise and pollution on site.

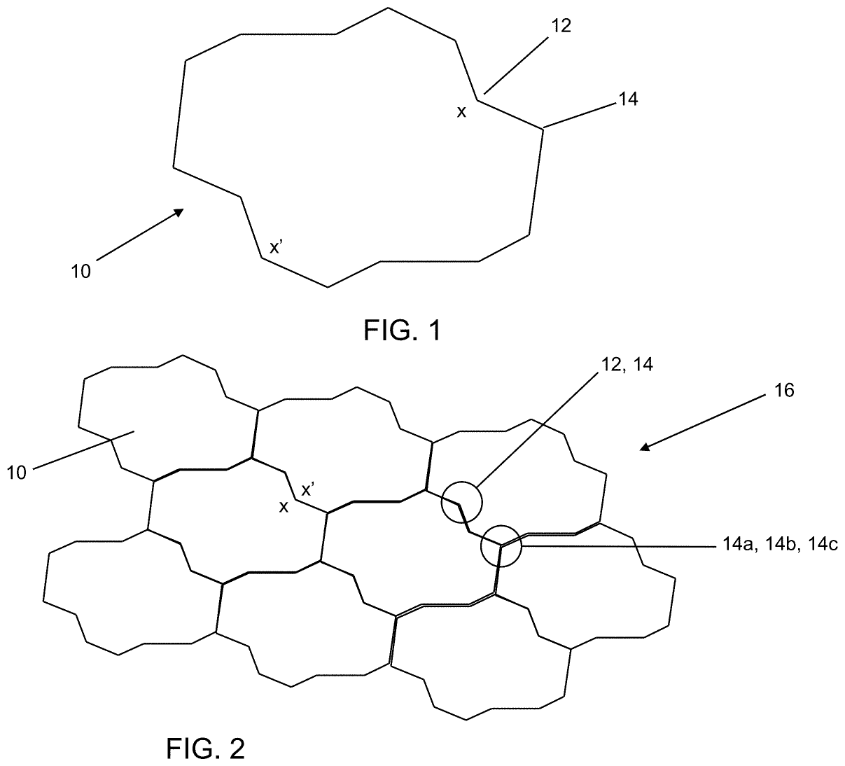

Turning now to the figures, FIG. 1 illustrates a tile or tessellation outline 10 that is configured to be tiled or tessellated in a pattern as shown in FIG. 2. The outline 10 forms an irregular concave polygon. That is, the outline 10 is shaped using straight lines that connect with each other to preferably form at least one concave vertex 12 and at least one convex vertex 14, with a total number of vertices being at a minimum three, but preferably more such as the example shown in FIG. 1. It may be noted that an outline 10 with all convex vertices 14 (i.e., an irregular convex polygon) can also be used but may reduce the random appearance of the resulting paved surface. The provision of both concave and convex vertices 12, 14 allows the tessellation outline 10 to be tiled as shown in FIG. 2 with little or no gaps in between the tessellation outline 10. The vertices 12, 14 also should have opposing counterparts. For example, concave vertex 12 denoted by x in FIG. 1 has a complementary convex vertex 14 denoted by x′ to permit these vertices to be placed adjacent to one another when tiled.

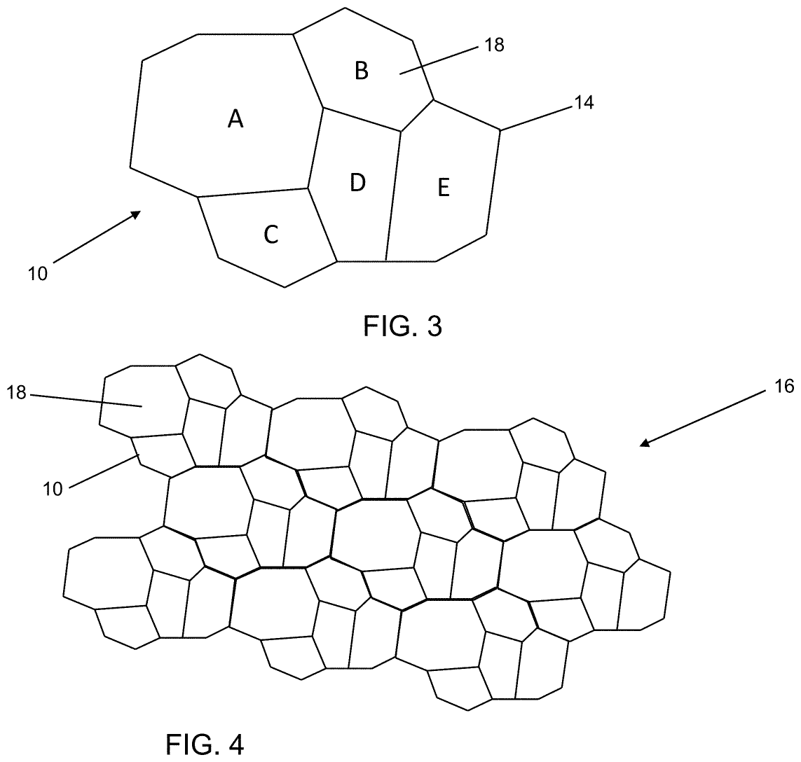

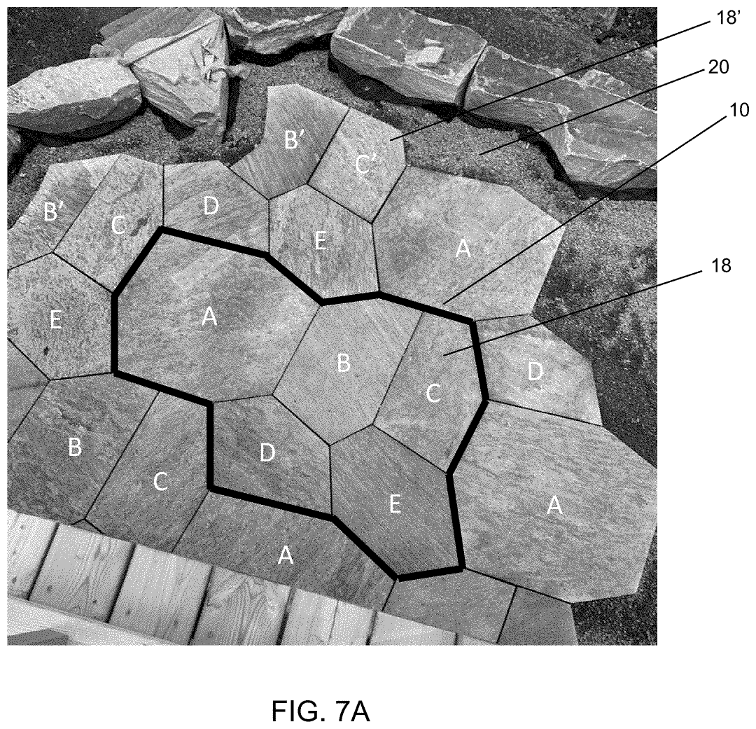

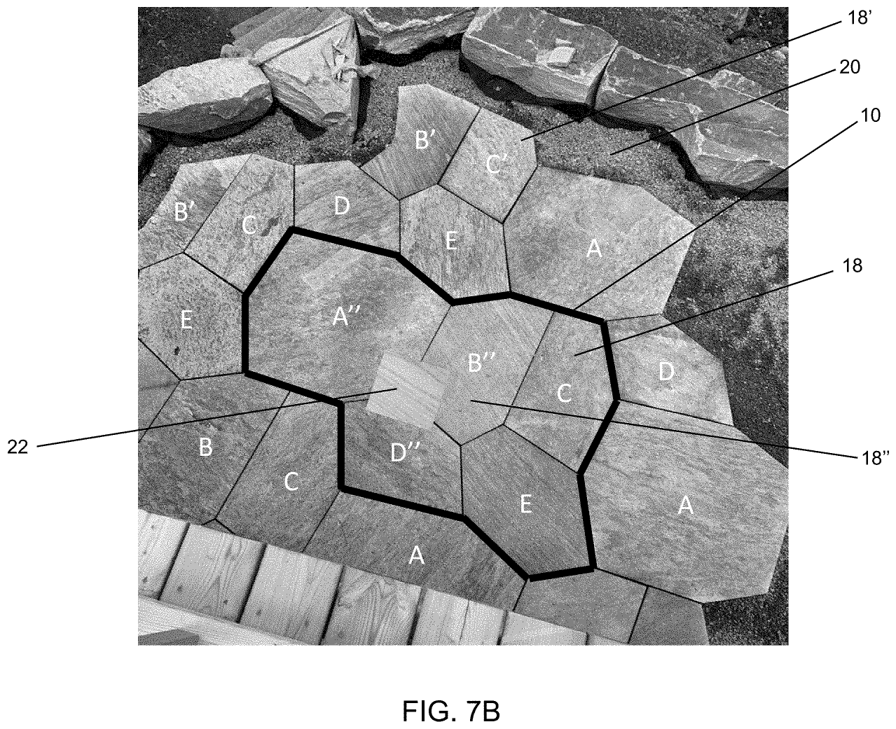

The tessellation outline 10 shown in FIGS. 1 and 2 provides a basis for designing and preparing the internal pattern that, when tessellated 16 as shown in FIG. 2, provides the desired perception or illusion of randomness. FIGS. 3 and 4 illustrate a first example in which the tessellation outline 10 is used as the basis for a set of five internal shapes 18 as illustrated using letters A, B, C, D, and E in FIG. 3. The internal shapes 18 are designed such that when combined (and taking into account the gaps created by the internal cuts—see below and FIGS. 7A-7B), all internal shapes and such gaps cover the entirety of the interior area of the tessellation outline 10. The internal shapes 18 can be considered irregular convex polygons. That is, in this example, each of the internal shapes 18 itself includes only convex vertices 14 to facilitate the easiest cutting methods of the shapes 18 from raw stone material. The individual internal shapes 18, once designed and sized to fit within the tessellation outline 10 as shown in FIG. 3, can be cut individually from any raw stone material. That is, there is no requirement that the internal shapes 18 be cut from the same slab of stone as the other internal stones 18 with which it will be laid. This allows the raw stone to be more efficiently utilized with as little waste as possible while also allowing for stones of different shades and color patterns to be combined in artistically interesting ways. The tessellation outline 10 can therefore be considered a guide or pattern for a set of internal stones 18 to guide the installation to create the perception of randomness seen in FIG. 4. That is, the internal stones 18 can be sent to site as a set and laid down according to the pattern.

When cutting stone tiles, it is desirable to perform the cuts so that the footprint of the resulting stone tiles will also include the gap(s) and thus be spaced between ⅜ inch and ½ inch apart when installed according the installation pattern. The purpose of the resulting gap is to hide the cutting tolerance variations that occur when cutting natural stone while maintaining the extents of the tessellation outline 10. Small deviations of the cut angle or variations in the exact flatness of the cut line are more visible when the gap between stones is very small. However, it is also recognized that gaps between individual stones, and thereby also the gap between tessellating outlines, may be larger than % inch wide and still maintain the perception or illusion of randomness provided that all gaps are essentially parallel and are of the same width.

It can be appreciated that while examples herein describe straight edge shapes, the principles discussed herein can be adapted to use curved edges and concave corners with a tradeoff in complexity of cutting, requiring more specialized cutting machinery and/or techniques. That is, the straight edges and convex corners of the irregular convex polygon shapes 18 greatly simplify cutting and decrease complexity in the process.

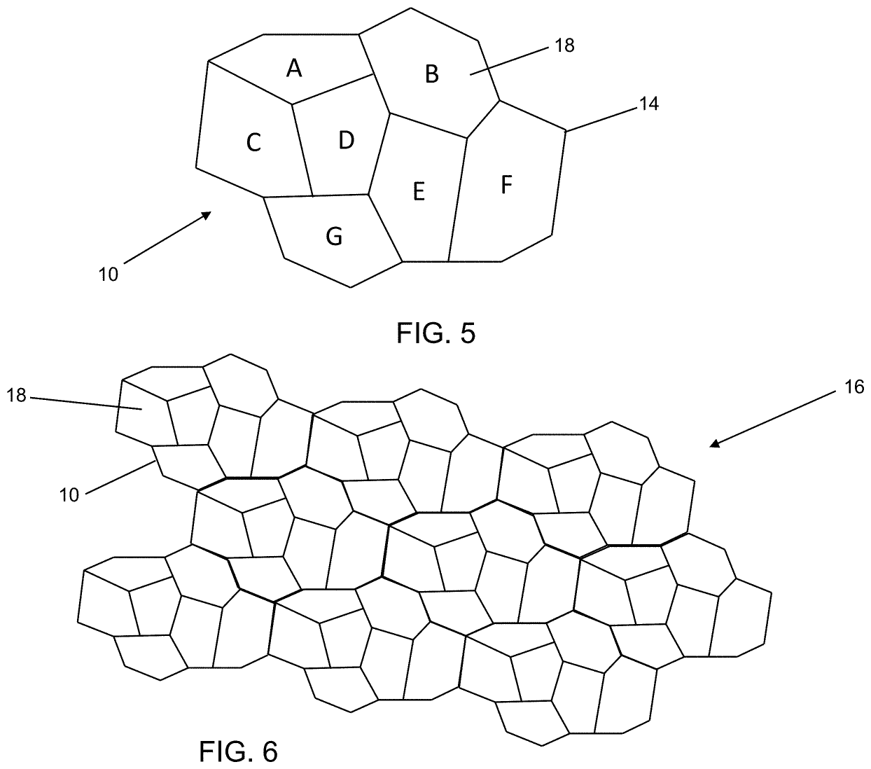

While FIGS. 3 and 4 illustrate an example having a set of five internal shapes 18, any plurality of shapes, either an odd or even number, can be used. It can be appreciated that more internal shapes used, the more randomized the pattern appears. For example, FIGS. 5 and 6 illustrate a second example in which the same tessellation outline 10 is used as the basis for a set of seven internal shapes 18, as illustrated using the letters A, B, C, D, E, F, and G. As with the first example, the internal shapes 18 are designed such that when combined (and taking into account the gaps created by the internal cuts), all internal shapes and such gaps cover the entirety of the interior area defined by the tessellation outline 10. Also, as with the first example, it can be observed that each of the internal shapes 18 in FIG. 5 can be considered an irregular convex polygon, which includes only convex vertices 14, to simplify cutting and placement within the outline 10, as explained above. The pattern and visual effect of the tessellation shown in FIG. 6, when compared to FIG. 4, has a greater perception or illusion of randomness to the observer. The tradeoff between these two examples is the increased perception or illusion of randomness versus the number of distinct shapes that need to be cut and installed to form a set. However, the raw material available to the designer/installer should also be considered since a large stock of relatively smaller stones may require or otherwise dictate the use of smaller individual shapes 18, thus creating a greater number of shapes 18 within the same tessellation outline 10. As such, the size of the set of internal shapes 18 can also be dictated by other external factors.

It can also be appreciated that while the examples in FIGS. 3-6 illustrate tiling the tessellation outline 10 using the same internal pattern or set, two or more different internal patterns with the same tessellation outline 10 could also be tiled. For example, an installer that has pre-cut inventory for two or more different sets could tile different sets together on site.

In general, the tessellation outline 10 is designed to form an irregular concave polygon, which includes three or more edges, with the fourteen-edge outline 10 shown in the present examples being advantageous but illustrative only, in that multiple convex vertices 14 and multiple concave vertices 12 can be formed with multiple opposing counterparts x/x′. More or fewer sides/edges is/are possible within the scope of the present disclosure. The number of sides can be chosen to increase or decrease the number of internal shapes 18 to balance the perception of randomness with the number of cuts, amount of inventory, and other factors affecting the set. For example, any number of internal shapes 18 can be patterned within the outline 10 but the more shapes 18 created the more cuts and inventory are needed and the installation time can increase. Moreover, the overall size of the tessellation outline 10 can vary, again balancing between the aesthetic appeal of larger internal stones 18 and the available stock of natural stone slabs.

FIGS. 7A and 7B provide an image of a small installation site with the tessellation outline 10 overlaid in the image using a thick bold virtual line for emphasis only, which would not be present in the actual installation. In this example, a set of five internal stones 18, marked A, B, C, D, and E is shown. A central set of shapes 18 is highlighted with the neighboring internal stones 18 placed adjacent the outer edges of each to begin creating the tessellating pattern. Also shown in the image of FIGS. 7A and 7B are boundaries 20 and obstructions 22. FIG. 7A illustrates a boundary region 20 in which modified shapes 18′ (B′, C′) are cut either beforehand or cut onsite to accommodate the external outer boundaries of the patio. To cut beforehand, a site plan can be used to lay out the tessellating pattern to determine which shapes 18 need to be cut to become modified shapes 18′. Alternatively, the pattern can be created onsite and only minor cuts applied at the installation stage when approaching a boundary region 20.

Similarly, as shown in FIG. 7B, an obstruction 22 such as a support post, tree, or other object may need to be accommodated within the boundary of the patio. In this case, the modified shapes A″, B″ and D″ are cut to accommodate the obstruction 22. As discussed above, this can be done in advance and offsite if an accurate site plan is available to work from.

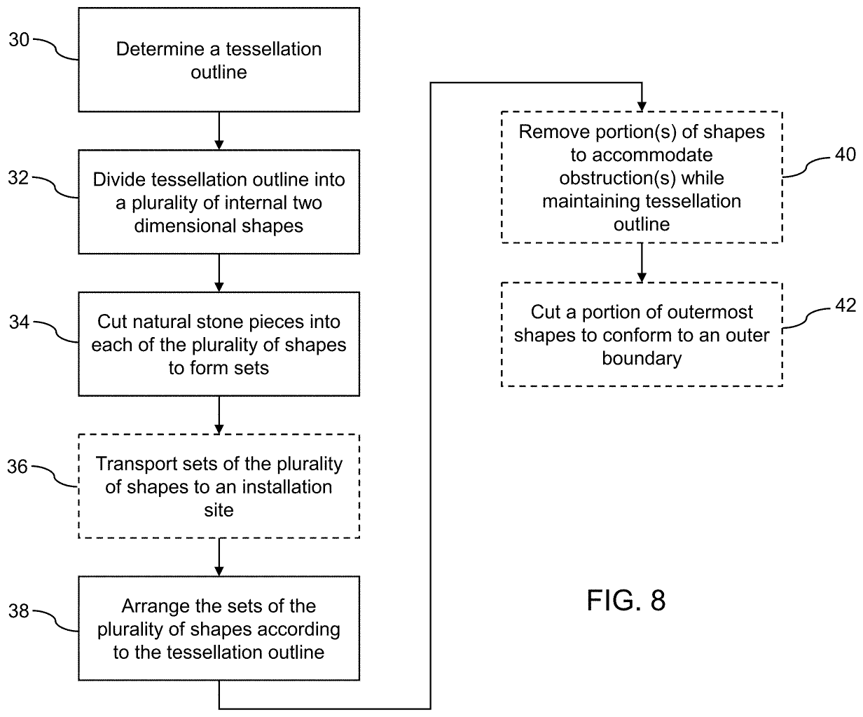

FIG. 8 illustrates a flow chart for the preparation and installation of a natural stone surface as herein described. At step 30, the overall tessellation outline 10 is obtained, determined or otherwise created or designed. The tessellation outline 10 may also require scaling based on the size the project. From the tessellation outline 10, at step 32 the outline 10 is divided into a plurality of internal two dimensional shapes 18, e.g., irregular convex polygon shapes as shown in FIGS. 3 and 5. The measurements of these shapes 18 are taken and can be used to create a template for each shape 18 in the set. At step 34, natural stone pieces are cut into each of the plurality of shapes to form sets of the internal stones 18. The number of complete sets and number of individual internal stones 18 can vary depending on the size of the project and various constraints such as the size of the available raw stone tiles. Therefore, step 32 can also include a sub-step of mapping the tessellation outline 10 and stones 18 to a site plan to determine the number of sets required and, if any incomplete sets are required, which individual stones 18 are needed. Of course, these efficiency measures may not be required if the maximum number of stones 18 is cut from an available stock of natural stone. Moreover, the pre-cutting can be done in bulk to create a standardized stock of stones for multiple jobs and need not be repeated or customized for each job.

Optionally, at step 36, the sets of shapes 18 (and/or any incomplete sets) are transported to an installation site. This step may be optional in some circumstances if all cutting is to be done onsite. That is, the principles described herein can also be applied completely onsite, e.g., for installations wherein cutting onsite is not considered disruptive or suitable offsite cutting tools are not available or needed. At step 38, the shapes 18 are then arranged according to the tessellation outline 10 such that for large areas the shapes 18 are grouped and laid in sets, as described above. Optionally, as also shown in dashed lines in FIG. 8, portions of some shapes 18 can be removed to accommodate obstructions at step 40 and portions of the outermost shapes 18 may be cut to conform to an outer boundary 20 as shown in FIGS. 7A and 7B. As noted above, it can be appreciated that steps 40 and 42 can instead be performed at step 34 if suitable knowledge of the site is known and can be reasonably guaranteed to allow for pre-cutting.

The sets of shapes 18 defined within the tessellation outline 10 can also be configured to include one or more reference lines corresponding to edges of certain shapes 18 in the set, which are orthogonal to or parallel/aligned to/with a direction along which the pattern repeats. A plurality of non-adjacent, collinear edges within the pattern can further simplify alignment when repeating the tessellation outline 10 in a tessellation pattern 16. In this way, the overall tessellation outline 10 can be cut either offsite or onsite in a consistent manner for installation. For example, this enables the installation of the pattern to begin against one or more reference edges such as walls, decks, grass lines or other boundaries, with reduced cutting onsite. This configuration also allows for standard fill pieces to be pre-cut (e.g., offsite) and reused on the opposite side to a reference edge. The configuration further facilitates the creation of walkways/paths through reduced cutting and the ability to reuse both portions of the cut material. It can be appreciated that this alignment configuration can be applied to any tiled product, including interior tiles and should not be considered limited to outdoor products.

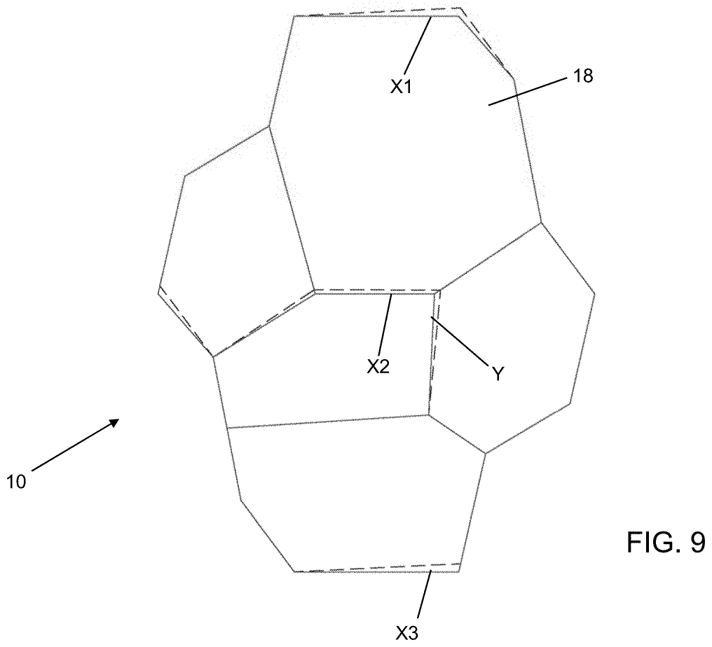

Referring now to FIG. 9, such an alignment configuration is illustrated using solid lines overlaid on dashed lines. In this example, the set of shapes 18 is purposefully configured to have a set of reference lines X1, X2, and X3 that are parallel to each other. Since X1 and X3 are exterior edges in the tessellation outline 10, the reference lines X1-X3 can in turn align the pattern against a reference edge that is parallel thereto. The tessellation outline 10 in this example also includes an orthogonal reference line Y that is perpendicular to the reference lines X1-X3. This enables the outline 10 to repeat in two different orthogonal directions with the choice being possible prior to installation (permitting offsite pre-cuts) or on-site adaptations with a reduced number of cuts. As discussed in greater detail below, the orthogonal reference lines X, Y also enable the tessellation outline 10 to be adapted to start within a reference corner and thereafter permit repetition in both directions outwardly from the reference corner. It can be appreciated that any one or more reference lines (X or Y, or X and Y) can be incorporated into the design of the shapes 18.

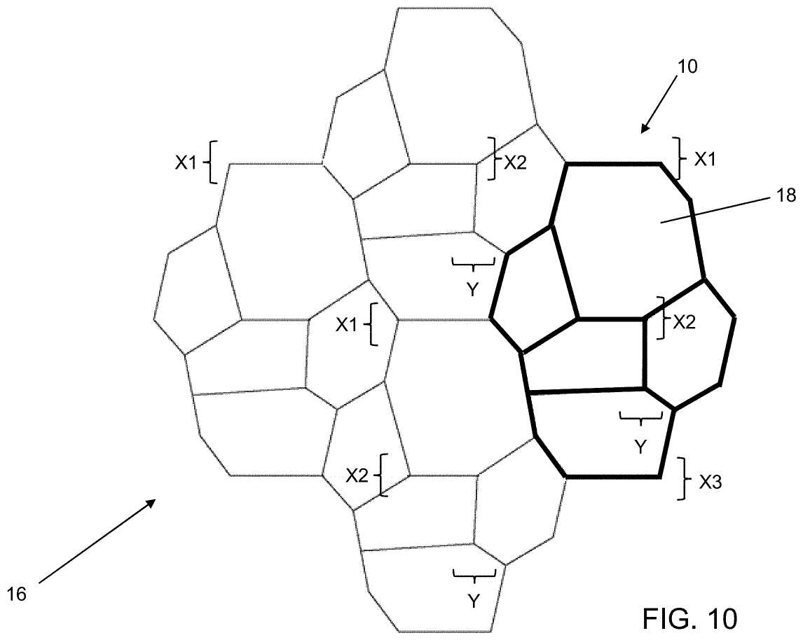

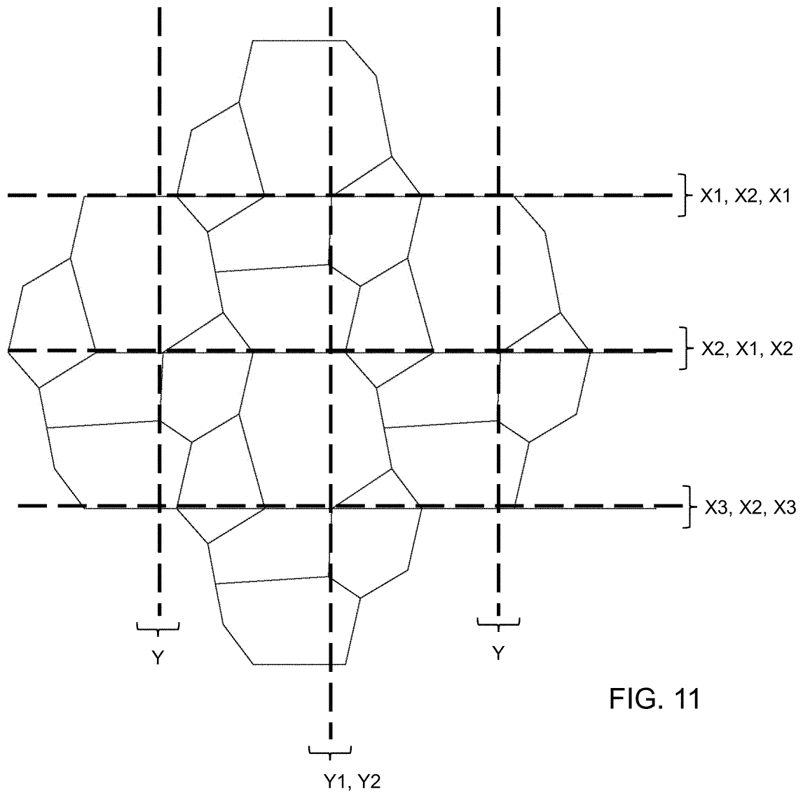

FIG. 10 illustrates a repeating tessellated pattern 16 of the set of shapes 18 shown in FIG. 9. Here it can be observed that reference line X1 in the highlighted set of shapes 18 is aligned with reference line X2 in the adjacent set of shapes 18, which is in turn aligned with reference line X1 in the next set of shapes 18. Similarly, X2 of the highlighted set of shapes 18 is aligned with X1 of another of the adjacent sets of shapes 18 while reference line X3 of the highlighted set of shapes 18 is aligned with reference line X2 of that same adjacent set of shapes 18. Similarly, orthogonal reference line Y is aligned in sets of shapes 18 repeating along that direction. Referring now to FIG. 11, this enables a grid of potential cut lines to be established and used for either pre-cutting or onsite cutting in a manner that can allow the repeating pattern to align with or otherwise create long continuous edges as discussed in greater detail below. From FIG. 11 various possibilities can be seen, including square and rectangular overall shapes, consistent repetitions along a reference edge or boundary, as well as the ability to easily begin the repeating pattern from a corner.

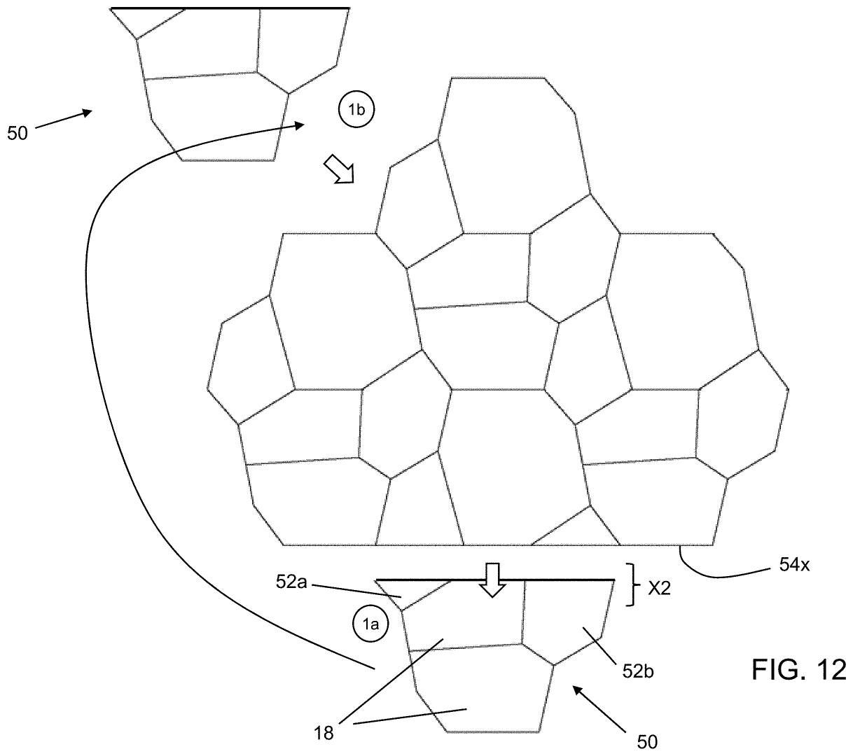

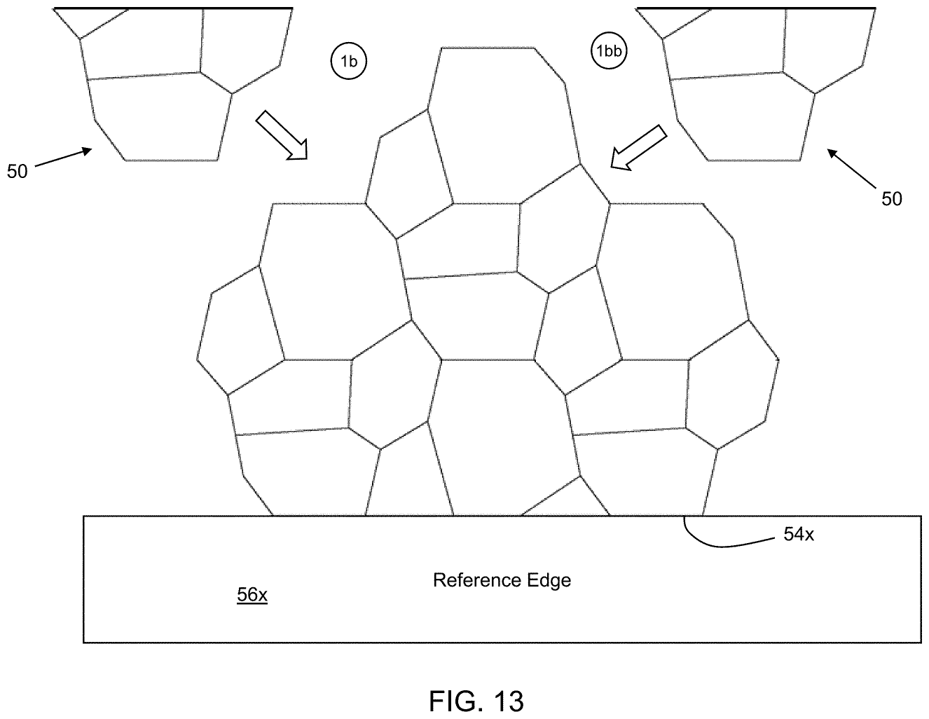

FIG. 12 illustrates a cutline 54x that removes a portion 50 of one of the sets of shapes 10 at step 1a. Here the portion includes two uncut shapes 18 and two fill pieces 52a and 52b. Any one or more of these pieces can be used in other parts of the pattern. In FIG. 12 the entire portion 50 is shown as being a candidate for fitment at the opposite end of the repeating pattern from the cutline 54x in step 1b. This can be done to finish a paved surface or to provide an opposite edge for a path or walkway. In this way, not only can the outer extents of the paved surface be completed with fewer cuts, but also less material is wasted since parallel cut lines repeat as the pattern repeats. FIG. 13 illustrates two candidate uses for the portion 50, in steps 1b or 1bb. Again, since portion 50 is cut from the pseudo random but repeatable tessellation outline 10, the cut portion 50 can be more readily reused and minimize cutting at the outer extents of the paved surface. FIG. 13 illustrates a reference edge 56x aligned with the reference lines X1, X2, X3 and which is embodied as a structure or other boundary against which the paved surface is to begin or end. For example, the reference edge 56x can represent a deck or wall from which the paved surface emerges and the cutline 54x can be readily prepared in advance offsite or with minimal effort onsite while permitting the repeating pattern to emanate from the cutline 54x.

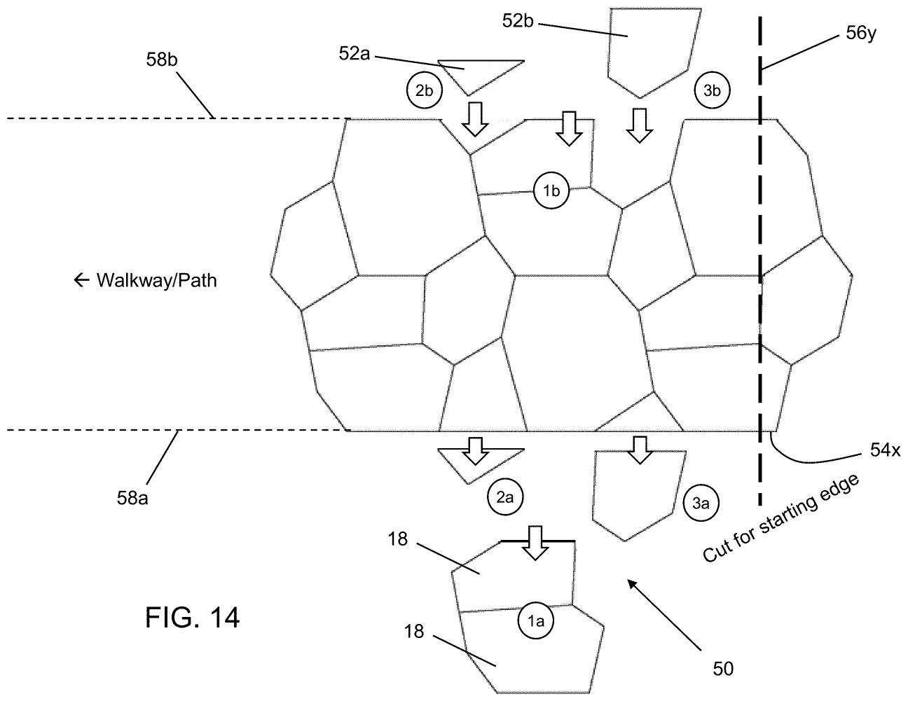

The alignment configuration utilizing one or more reference lines (X1, X2, . . . Y1, Y2 . . . ) is particularly suitable for creating paths and walkways from the sets of shapes 18. Such walkways/paths can be part of or an extension to a paved surface created using the sets of shapes 18 or can be the paved surface in and of itself. Referring now to FIG. 14, an example is shown in which the individual shapes 18 and fill pieces 52 from a set along the reference edge 54x that aligns with a one side 58a of a walkway, can be reused along the other opposite side 58b of the walkway by fitting the uncut shapes 18 removed at step 1a within a gap opposite where the cuts were made at step 1b. Similarly, the fill pieces 52a, 52b removed at steps 2a and 3a can be used to fill in the remaining portions of the gap at steps 2b and 3b. Also shown in FIG. 14 is an orthogonal reference cut line 56y that could be used to square off the walkway or path at one end, e.g., to delineate the entry or starting point of the walkway or path. It can be appreciated that walkway or path can be created without requiring a reference line (i.e., can be left “as-is”) or can adopt other non-orthogonal cut lines (not shown) as desired. In either scenario, the number of cuts required to create the walkway using the same set of shapes 18 in the tessellation outline 10 can be significantly reduced.

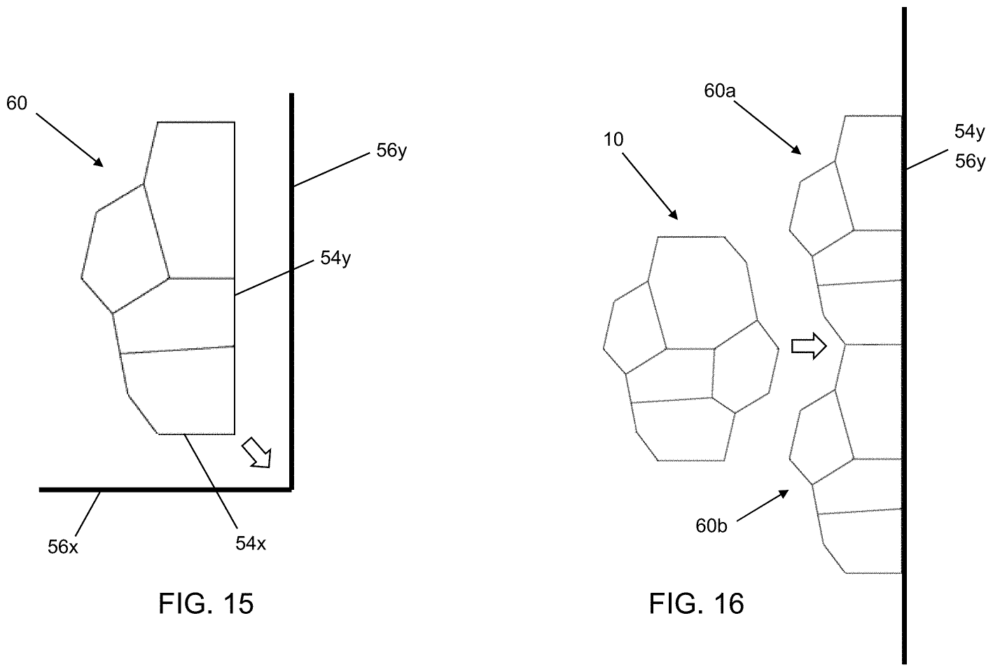

FIG. 15 illustrates that pre-cutting or on-site cutting can be used to readily begin a paved surface from a corner, by cutting along the orthogonal cut line Y until it intersects cut line X3 to create a 90 degree corner. In this way, only a single cut is needed to begin a paving job from a corner and this single cut can be done ahead of time and offsite to minimize the onsite cutting and time required. FIG. 16 illustrates yet another scenario wherein the desired reference edge 56y is aligned with the orthogonal cut line 54y and multiple ones of the set of shapes 18 are cut along the orthogonal cut line 54y to enable the tessellated pattern 16 to repeat along that edge 56y while the pattern can repeat away from this line as shown without requiring further cuts until an edge or obstruction is encountered.

It can be seen that the pseudo random pattern of the shapes 18 with the tessellation outline 10 can be configured to include alignment lines that are parallel to or otherwise aligned with a reference edge 56 to allow the pattern to repeat while providing convenient cutoff edges for the outer extents of the paved surface. Moreover, these predictable cutoff edges allow additional precutting to be done offsite and/or inventory to be created of the set of shapes 18 in which reference edges and corners can be accommodated.

For simplicity and clarity of illustration, where considered appropriate, reference numerals may be repeated among the figures to indicate corresponding or analogous elements. In addition, numerous specific details are set forth in order to provide a thorough understanding of the examples described herein. However, it will be understood by those of ordinary skill in the art that the examples described herein may be practiced without these specific details. In other instances, well-known methods, procedures and components have not been described in detail so as not to obscure the examples described herein. Also, the description is not to be considered as limiting the scope of the examples described herein.

It will be appreciated that the examples and corresponding diagrams used herein are for illustrative purposes only. Different configurations and terminology can be used without departing from the principles expressed herein. For instance, components and modules can be added, deleted, modified, or arranged with differing connections without departing from these principles.

The steps or operations in the flow charts and diagrams described herein are just for example. There may be many variations to these steps or operations without departing from the principles discussed above. For instance, the steps may be performed in a differing order, or steps may be added, deleted, or modified.

Although the above principles have been described with reference to certain specific examples, various modifications thereof will be apparent to those skilled in the art as outlined in the appended claims.

1. A method of preparing a set of natural stone shapes for installation as a tiled surface, comprising:
determining a tessellation outline comprising three or more sides;
dividing the tessellation outline into a plurality of internal two dimensional shapes, wherein at least one of the plurality of shapes comprises an edge defining a reference line that is orthogonal or parallel to a repeating direction of installation; and
cutting one or more natural stone slabs into each of the plurality of shapes to form at least one set.

2. The method of claim 1, wherein a first pair of the three or more sides forms a first concave vertex, and a second pair of the three or more sides forms a second convex vertex to define the tessellation outline as an irregular concave polygon.

3. The method of claim 2, wherein the first concave vertex and the first convex vertex are counterparts to each other such that in one set the first convex vertex aligns substantially with the first concave vertex in another set when the sets are laid adjacent one another.

4. The method of claim 1, wherein the tessellation outline is divided into a set of comprising an odd number of internal shapes.

5. The method of claim 1, wherein the tessellation outline is divided into a set comprising an even number of internal shapes.

6. The method of claim 1, wherein each of the plurality of internal two dimensional shapes is formed as an irregular convex polygon comprising all convex vertices.

7. The method of claim 1, wherein a pair of outer edges of the tessellation outline are parallel to each other, the pair of outer edges being reference lines.

8. The method of claim 7, wherein an inner edge is included between the pair of outer edges, the inner edge being parallel to the outer edges.

9. The method of claim 7, wherein an orthogonal reference line is incorporated into the plurality of shapes.

10. The method of claim 1, wherein the plurality of shapes defines at least two reference lines that are orthogonal to each other.

11. The method of claim 1, wherein the plurality of shapes are cut to include gaps between the plurality of shapes when laid according to the tessellation outline.

12. A method of installing a tiled natural stone surface, comprising:
cutting one or more natural stone slabs into each of a plurality of two dimensional shapes that form at least one set of shapes, wherein each set of shapes, when combined, form a tessellation outline comprising three or more sides, and wherein at least one of the plurality of shapes comprises an edge defining a reference line that is orthogonal or parallel to a repeating direction of installation; and
arranging the plurality of shapes according to the tessellation outline to install the natural stone surface.

13. The method of claim 12, further comprising transporting the cut shapes from an offsite location to an onsite location wherein the stone surface is to be installed.

14. The method of claim 12, wherein at least one complete set of shapes is installed.

15. The method of claim 12, further comprising
determining a boundary edge; and
cutting a portion from at least one of the internal shapes along at least one reference line.

16. The method of claim 15, wherein a plurality of cuts are made along a plurality of reference lines to accommodate the boundary constraint or obstruction.

17. The method of claim 12, wherein a pair of outer edges of the tessellation outline are parallel to each other, the pair of outer edges being reference lines.

18. The method of claim 17, wherein an inner edge is included between the pair of outer edges, the inner edge being parallel to the outer edges.

19. The method of claim 17, wherein an orthogonal reference line is incorporated into the plurality of shapes.

20. The method of claim 12, wherein the plurality of shapes defines at least two reference lines that are orthogonal to each other.

21. A tiled natural stone paving system, comprising a plurality of two dimensional shapes cut from natural stone that form at least one set of shapes, wherein each set of shapes, when combined, form a tessellation outline comprising three or more sides, wherein the plurality of shapes are arranged according to the tessellation outline and the outline is tessellated to create the natural stone surface, and wherein at least one of the plurality of shapes comprises an edge defining a reference line that is orthogonal or parallel to a repeating direction of installation.

22. The system of claim 21, wherein a pair of outer edges of the tessellation outline are parallel to each other, the pair of outer edges being reference lines.

23. The system of claim 22, wherein an inner edge is included between the pair of outer edges, the inner edge being parallel to the outer edges.

24. The system of claim 22, wherein an orthogonal reference line is incorporated into the plurality of shapes.

25. The system of claim 21, wherein the plurality of shapes defines at least two reference lines that are orthogonal to each other.
